(19) United States
(12) Patent Application Publication
(10) Pub. No.: US 2026/0302413 A1
(43) Pub. Date: Oct. 1, 2026

(54) BATTERY PACK

(71) Applicant: MURATA MANUFACTURING CO., LTD., Kyoto (JP)

(72) Inventor: Hideyasu TAKATSUJI, Kyoto (JP)

(21) Appl. No.: 19/437,781

(22) Filed: Dec. 31, 2025

(30) Foreign Application Priority Data
Mar. 28, 2025 (JP) 2025-055755

(51) Int. Cl. H01M 10/6554; H01M 50/213; H01M 50/291; H01M 50/503; H01M 50/522

(52) U.S. Cl. CPC H01M 10/6554; H01M 50/213; H01M 50/291; H01M 50/503; H01M 50/522

(57) ABSTRACT

A battery pack includes a plurality of batteries, a plurality of energization tabs, a heat dissipation sheet, and a housing. The batteries each include a terminal. The energization tabs are coupled to the respective terminals of the batteries. The heat dissipation sheet is in contact with the energization tabs. The housing houses the batteries, the energization tabs, and the heat dissipation sheet and is in contact with the heat dissipation sheet. The heat dissipation sheet has a member pattern corresponding to a layout of the respective terminals of the batteries and a layout of the energization tabs.

### CROSS-REFERENCE TO RELATED APPLICATIONS

The present application claims priority from Japanese Patent Application No. 2025-055755 filed on Mar. 28, 2025, the entire contents of which are hereby incorporated by reference.

### BACKGROUND

The present disclosure relates to a battery pack.

Electronic equipment has been widely used. Such widespread use has promoted development of a battery as a power source that is to be applied to the electronic equipment. In relation to this, a battery pack including a plurality of batteries has been proposed to easily and safely handle the batteries.

A technique related to a configuration of the battery pack has been considered in various ways. For example, a technique is disclosed of dissipating heat built up inside the battery pack to an outside of the battery pack.

### SUMMARY

The present disclosure relates to a battery pack.

If batteries included in a battery pack vary in temperature upon current application to the batteries, the batteries can vary in characteristic or lifetime. It is desirable to provide a battery pack that makes it possible to reduce a possibility of batteries varying in characteristic or lifetime.

A battery pack according to an embodiment of the present disclosure includes a plurality of batteries, a plurality of energization tabs, a heat dissipation sheet, and a housing. The batteries each include a terminal. The energization tabs are coupled to the respective terminals of the batteries.

The heat dissipation sheet is in contact with the energization tabs. The housing houses the batteries, the energization tabs, and the heat dissipation sheet and is in contact with the heat dissipation sheet. The heat dissipation sheet has a member pattern corresponding to a layout of the respective terminals of the batteries and a layout of the energization tabs.

### BRIEF DESCRIPTION OF THE FIGURES

The accompanying drawings are included to provide a further understanding of the present disclosure and are incorporated in and constitute a part of this specification. The drawings illustrate example embodiments and, together with the specification, serve to explain the principles of the present disclosure.

FIG. 1 is a diagram illustrating a perspective configuration example of a battery pack according to an embodiment of the present disclosure.

FIG. 2 is a diagram illustrating a perspective configuration example of a battery module that is one of contents of the battery pack.

FIG. 3 is a diagram illustrating an exploded perspective configuration example of the battery pack.

FIG. 4 is a diagram illustrating a sectional configuration example of a battery holder.

FIG. 5 is a diagram illustrating a plan configuration example of the battery pack in a state where an upper casing or a lower casing is removed.

FIG. 6 is a diagram illustrating a sectional configuration example of the battery pack.

FIG. 7 is a diagram illustrating a heat generation distribution example of batteries in a battery pack according to a comparative example with no heat dissipation sheet.

FIG. 8 is a diagram illustrating a layout example of an energization tab when a control board and the energization tab are coupled to the battery module.

FIG. 9 is a diagram illustrating a plan configuration example of a heat dissipation sheet.

FIG. 10 is a diagram illustrating an example of respective areas of first heat dissipation parts in the heat dissipation sheet.

FIG. 11A is a diagram illustrating a plan configuration example of a left end part of the heat dissipation sheet.

FIG. 11B is a diagram illustrating a plan configuration example of a right end part of the heat dissipation sheet.

FIG. 12 is a diagram illustrating a perspective configuration example of the heat dissipation sheet.

FIG. 13 is a diagram illustrating a sectional configuration example of the battery pack.

FIG. 14 is a diagram illustrating a modification example of a perspective configuration of the heat dissipation sheet.

FIG. 15 is a diagram illustrating a sectional configuration example of the battery pack including the heat dissipation sheet illustrated in FIG. 14.

FIG. 16 is a diagram illustrating a sectional configuration of the battery pack including the heat dissipation sheet illustrated in FIG. 14 according to an embodiment.

FIG. 17 is a diagram illustrating a modification example of the sectional configuration of the battery pack including the heat dissipation sheet illustrated in FIG. 12.

FIG. 18 is a diagram illustrating the sectional configuration of the battery pack according to an embodiment.

FIG. 19 is a diagram illustrating a heat generation distribution of a plurality of batteries in a battery pack according to each of Comparative examples 1 and 2.

FIG. 20 is a diagram describing, with numerical values, the heat generation distributions illustrated in FIG. 19.

FIG. 21 is a diagram illustrating a heat generation distribution of a plurality of batteries in a battery pack according to Example 1 and the heat generation distribution of the batteries in the battery pack according to Comparative example 1.

FIG. 22 is a diagram describing, with numerical values, the heat generation distributions illustrated in FIG. 21.

FIG. 23 is a diagram illustrating a heat generation distribution of a plurality of batteries in a battery pack according to Example 2 and the heat generation distribution of the batteries in the battery pack according to Comparative example 1.

FIG. 24 is a diagram describing, with numerical values, the heat generation distributions illustrated in FIG. 23.

FIG. 25 is a diagram illustrating a heat generation distribution of a plurality of batteries in a battery pack according to Example 3 and the heat generation distribution of the batteries in the battery pack according to Comparative example 1.

FIG. 26 is a diagram describing, with numerical values, the heat generation distributions illustrated in FIG. 25.

FIG. 27A is a diagram illustrating a modification example of a plan configuration of the left end part of the heat dissipation sheet.

FIG. 27B is a diagram illustrating a modification example of a plan configuration of the right end part of the heat dissipation sheet.

### DETAILED DESCRIPTION

The present disclosure relates to a battery pack.

In the following, the present disclosure is described in further detail including with reference to the accompanying drawings according to an embodiment. Note that the following description is directed to illustrative examples of the present disclosure and not to be construed as limiting to the present disclosure. Factors including, without limitation, numerical values, shapes, materials, components, positions of the components, and how the components are coupled to each other are illustrative only and not to be construed as limiting to the present disclosure. Further, elements in the following example embodiments which are not recited in a most-generic independent claim of the present disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the present disclosure are unillustrated in the drawings.

A description is given first of a battery pack 1 according to an example embodiment of the present disclosure.

The battery pack 1 to be described below may be an electric power source including a plurality of batteries, and may be applied to various applications including, without limitation, electronic equipment. Details of the applications of the battery pack 1 will be described later. Each of the batteries is not limited to a particular kind. In an embodiment, each of the batteries may be a primary battery. In an embodiment, each of the batteries may be a secondary battery. The secondary battery is not particularly limited in kind. Non-limiting examples of the secondary battery include a lithium-ion secondary battery in which a battery capacity is obtained through insertion and extraction of lithium ions. The number of the batteries is not particularly limited, and may be chosen as desired. The description below deals with an example case where the batteries are the secondary batteries, for example, the lithium-ion secondary batteries. In other words, the battery pack 1 to be described below may be an electric power source including a plurality of secondary batteries.

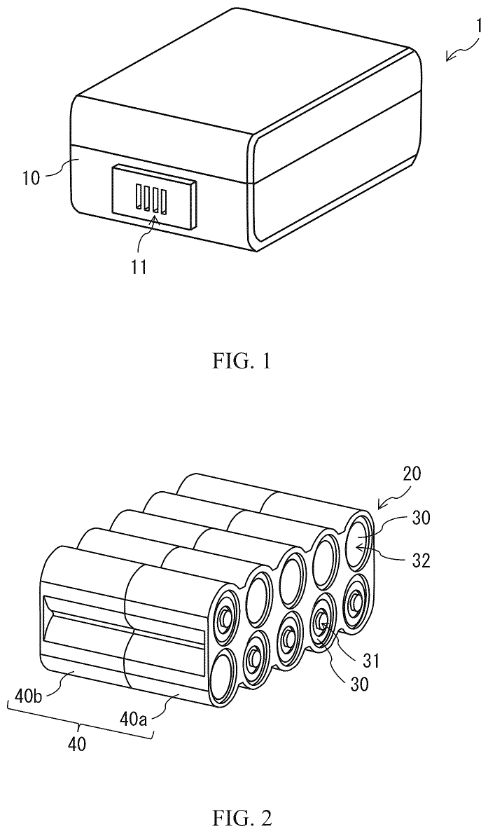

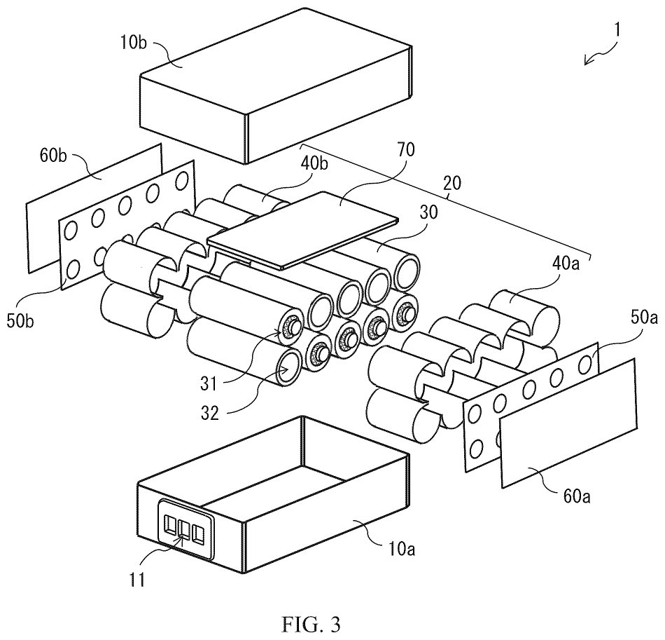

FIG. 1 illustrates a perspective configuration example of the battery pack 1 according to the example embodiment of the present disclosure. FIG. 2 illustrates a perspective configuration example of some of contents of the battery pack 1. FIG. 3 illustrates an exploded perspective configuration example of the contents of the battery pack 1.

As illustrated in FIGS. 1 and 2, the battery pack 1 may include, for example, an outer casing 10 and a battery module 20. The battery module 20 may be housed in the outer casing 10. As illustrated in FIG. 3, the battery pack 1 may further include, for example, energization tabs 50a and 50b, heat dissipation sheets 60a and 60b, and a control board 70. The outer casing 10 may correspond to a specific but non-limiting example of a “housing” in an embodiment of the present disclosure. The energization tabs 50a and 50b may correspond to a specific but non-limiting example of “a plurality of energization tabs” in an embodiment of the present disclosure. The heat dissipation sheet 60a may correspond to a specific but non-limiting example of a “heat dissipation sheet” in an embodiment of the present disclosure. Note that illustration of the heat dissipation sheets 60a and 60b in FIG. 3 is simplified for convenience, and illustrated shapes of the heat dissipation sheets 60a and 60b may differ from actual shapes of the heat dissipation sheets 60a and 60b.

The outer casing 10 may include, for example, a lower casing 10a and an upper casing 10b, as illustrated in FIG. 3. The lower casing 10a and the upper casing 10b may be stacked on each other to form a housing space for housing the battery module 20, the energization tabs 50a and 50b, the heat dissipation sheets 60a and 60b, and the control board 70. The outer casing 10 may be configured to house the battery module 20, the energization tabs 50a and 50b, the heat dissipation sheets 60a and 60b, and the control board 70. The outer casing 10, for example, the lower casing 10a, may be provided with an external terminal 11 coupled to the control board 70. A plurality of batteries 30, which will be described later, may be coupled to the external terminal 11 via the control board 70. The batteries 30 may correspond to a specific but non-limiting example of “a plurality of batteries” in an embodiment of the present disclosure.

The outer casing 10 may include, for example, a resin material such as polyethylene (PE), polypropylene (PP), polycarbonate (PC), modified polyphenylene ether (mPPE), polyamide (PA), polybutylene terephthalate (PBT), acrylonitrile-butadiene-styrene copolymer synthetic resin (ABS), or polyacetal (POM). In an embodiment, the outer casing 10 may include, for example, a resin material in which an electrically conductive material such as a metal or an electrically conductive filler is dispersed. In an embodiment, the resin material in which the electrically conductive material is dispersed may be any of the above-described resin materials.

The battery pack 1 may have a discharge mode in which electric power outputted from the battery module 20 is supplied to a load via the external terminal 11. In an embodiment, the battery pack 1 may further have a charge mode in which the battery module 20 stores electric power supplied via the external terminal 11 from an electric power source coupled to the external terminal 11. When the batteries 30 are the secondary batteries, the control board 70 may perform switching between the discharge mode and the charge mode, depending on a kind of what is coupled to the external terminal 11. When the batteries 30 are the primary batteries, the control board 70 may allow for the discharge mode without allowing for the charge mode. The control board 70 may be, for example, in contact with an upper surface of the battery holder 40. The control board 70 may be fixed to the upper surface of the battery holder 40 by a method such as pressure application, screwing, use of an adhesive agent, or ultrasonic welding.

The battery module 20 may include, for example, the batteries 30 and the battery holder 40 configured to support the batteries 30. The battery holder 40 may correspond to a specific but non-limiting example of a “battery holder” in an embodiment of the present disclosure. The batteries 30 may be electrically coupled to each other via the energization tabs 50a and 50b. For example, the batteries 30 may be coupled in series to each other via the energization tabs 50a and 50b. Note that how the batteries 30 are coupled to each other is not limited to the above. In an embodiment, two or more of the batteries 30 may be coupled in series to each other via the energization tabs 50a and 50b, and where the two or more batteries 30 coupled in series to each other is referred to as a series-coupled unit, a plurality of series-coupled units may be coupled in parallel to each other via the energization tabs 50a and 50b.

Each of the energization tabs 50a and 50b may include, for example, a metal lead plate. In an embodiment, each of the energization tabs 50a and 50b may be configured to allow a temperature of each of the batteries 30 at a time of energization to be higher than a temperature of each of the energization tabs 50a and 50b at the time of the energization. The temperature of each of the batteries 30 and the energization tabs 50a and 50b may be measured as follows. For example, in a state where the outer casing 10 and the heat dissipation sheets 60a and 60b are removed from the battery pack 1, the temperature of each of the batteries 30 and the energization tabs 50a and 50b may be measured while discharging is performed at 1 C. A value of the temperature of each of the batteries 30 and the energization tabs 50a and 50b measured when the temperature of corresponding one of the batteries 30 and the energization tabs 50a and 50b becomes stable may be used as the above-described temperature of corresponding one of the batteries 30 and the energization tabs 50a and 50b. In an embodiment, each of the energization tabs 50a and 50b may include, for example, Cu. Each of the batteries 30 may be a primary battery or a secondary battery. When each of the batteries 30 is the secondary battery, the secondary battery is not particularly limited in kind. Non-limiting examples of the secondary battery may include a lithium-ion secondary battery in which a battery capacity is obtained through insertion and extraction of lithium ions. The description below deals with an example case where each of the batteries 30 is the secondary battery, for example, the lithium-ion secondary battery. In other words, the battery pack 1 to be described below may be an electric power source including a plurality of secondary batteries.

The battery 30 may include two end faces opposed to each other. The battery 30 may extend in a first direction in which the two end faces are opposed to each other. The energization tabs 50a and 50b may be disposed at respective positions opposed to each other in the first direction, with the batteries 30 interposed between the energization tab 50a and the energization tab 50b. The battery 30 may include a positive electrode 31 and a negative electrode 32. The positive electrode 31 may be disposed at one of the two end faces. The negative electrode 32 may be disposed at another of the two end faces at which the positive electrode 31 is not disposed. FIG. 3 illustrates an example state in which the respective positive electrodes 31 of five of the ten batteries 30 and the respective negative electrodes 32 of another five of the ten batteries 30 face the energization tab 50a.

The battery 30 may have, for example, a circular columnar shape that extends in the first direction. Each of the end faces of the battery 30 may have, for example, a circular shape. The shape of the battery 30 is not limited to the circular columnar shape. The shape of each of the end faces of the battery 30 is not limited to the circular shape. The positive electrode 31 may include a metal member. The positive electrode 31 may have a protruding shape at the end face of the battery 30. The negative electrode 32 may include a metal member. The negative electrode 32 may form a flat surface at the end face of the battery 30.

The batteries 30 may be disposed side by side in two dimensional directions orthogonal to a longitudinal direction, i.e., the first direction, of the batteries 30. Here, the “two dimensional directions” may refer to a second direction orthogonal to the first direction, and a third direction orthogonal to both the first and the second directions. One of the two end faces of each of the batteries 30 provided in the battery pack 1 may be disposed in a first plane, and another of the two end faces of each of the batteries 30 provided in the battery pack 1 may be disposed in a second plane. The energization tab 50a may be in direct contact with the electrodes disposed in the first plane, or may be in contact, via an electrically conductive material such as solder, with the electrodes disposed in the first plane. The energization tab 50b may be in direct contact with the electrodes disposed in the second plane, or may be in contact, via an electrically conductive material such as solder, with the electrodes disposed in the second plane.

As used herein, an “extending direction of the battery 30” may refer to a direction parallel or substantially parallel to a direction in which the two end faces are opposed to each other when the battery 30 has a columnar shape extending in the direction in which the two end faces are opposed to each other.

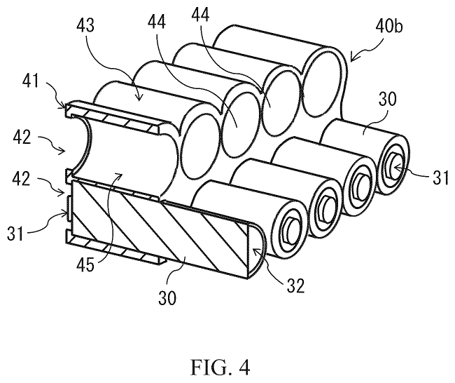

FIG. 4 illustrates a sectional configuration example of the battery holder 40. The battery holder 40 may include, for example, a pair of holders 40a and 40b, as illustrated in FIGS. 3 and 4. The holders 40a and 40b may have respective structures that are similar to each other.

Each of the holders 40a and 40b may include, for example, a side plate part 41, as illustrated in FIG. 4. The side plate part 41 of the holder 40a and the side plate part 41 of the holder 40b may be opposed to each other in the extending direction of each of the batteries 30, i.e., the first direction, with the batteries 30 interposed therebetween. The side plate part 41 of each of the holders 40a and 40b may have an opening part 42 at a position opposed to corresponding one of the positive electrode 31 and the negative electrode 32 of each of the batteries 30. Accordingly, the positive electrode 31 or the negative electrode 32 may be exposed at the opening part 42. The energization tab 50a may be disposed in proximity to the side plate part 41 of the holder 40a. The energization tab 50a may be in direct contact with the positive electrode 31 or the negative electrode 32 of each of the batteries 30 through the opening part 42 of the holder 40a, or may be in contact, via an electrically conductive material such as solder, with the positive electrode 31 or the negative electrode 32 of each of the batteries 30 through the opening part 42 of the holder 40a. The energization tab 50b may be disposed in proximity to the side plate part 41 of the holder 40b. The energization tab 50b may be in direct contact with the positive electrode 31 or the negative electrode 32 of each of the batteries 30 through the opening part 42 of the holder 40b, or may be in contact, via an electrically conductive material such as solder, with the positive electrode 31 or the negative electrode 32 of each of the batteries 30 through the opening part 42 of the holder 40b.

Each of the holders 40a and 40b may further include, for example, a support part 43 that supports the batteries 30 in a layered state with predetermined spacings between the batteries 30, as illustrated in FIG. 4. FIG. 4 illustrates an example state in which the support part 43 is so provided as to support the batteries 30 in two layers, i.e., a lowermost layer and an uppermost layer. The lowermost layer may be a layer at the bottom when the battery pack 1 or the battery module 20 is viewed in a direction illustrated in FIG. 4. In an embodiment, the lowermost layer may be a layer closest to the lower casing 10a. The uppermost layer may be a layer at the top when the battery pack 1 or the battery module 20 is viewed in the direction illustrated in FIG. 4. In an embodiment, the uppermost layer may be a layer closest to the upper casing 10b.

The support part 43 may have one end part coupled to the side plate part 41, and another end part including an opening part 44. The support part 43 may include a housing part 45 coupled to the opening part 42 and the opening part 44. The housing part 45 may house a part of the batteries 30. The housing part 45 may have a structure configured to house the batteries 30 in a state where the respective end faces of the batteries 30 face the same or substantially the same direction, i.e., a direction toward the energization tab 50a. When each of the batteries 30 has the circular columnar shape extending in the first direction, the housing part 45 may have, for example, spaces each having a circular columnar shape extending in the first direction.

The battery holder 40 may include, for example, a resin material such as polyethylene (PE), polypropylene (PP), polycarbonate (PC), modified polyphenylene ether (mPPE), polyamide (PA), polybutylene terephthalate (PBT), an acrylonitrile-butadiene-styrene copolymer synthetic resin (ABS), or polyacetal (POM). In an embodiment, the battery holder 40 may have a thickness within a range that allows for easy molding, for example. In an embodiment, the thickness of the battery holder 40 may be greater than or equal to 0.5 mm and less than or equal to 5 mm, for example.

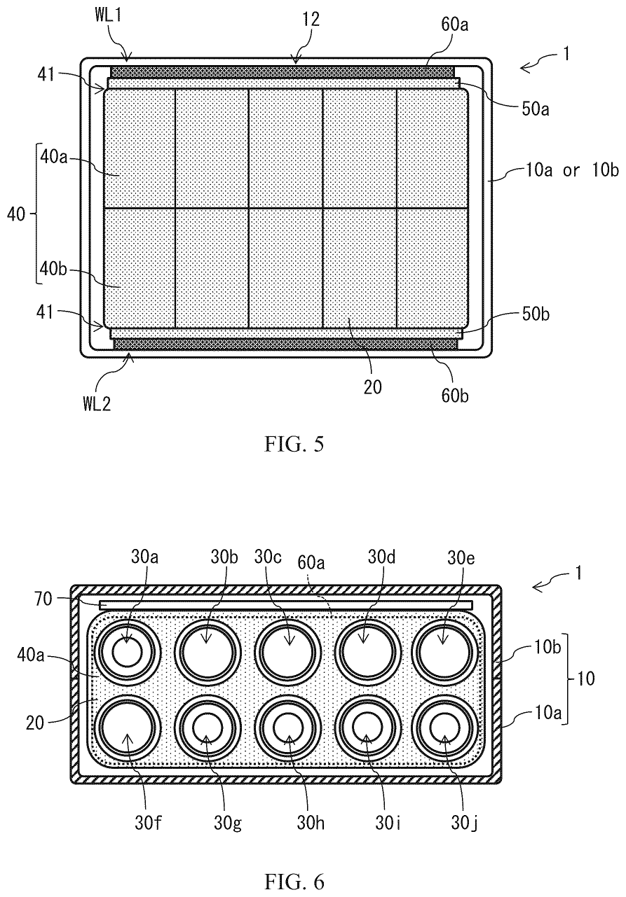

FIG. 5 illustrates a plan configuration example of the battery pack 1 in a state where the lower casing 10a or the upper casing 10b is removed. FIG. 6 illustrates a sectional configuration example of the battery pack 1. FIG. 6 illustrates an example state in which the holder 40a is so provided as to support ten batteries 30 in two layers, i.e., the lowermost layer and the uppermost layer. FIG. 6 illustrates a state in which five batteries 30, i.e., batteries 30a, 30b, 30c, 30d, and 30e, are disposed side by side in one line in the uppermost layer, and another five batteries 30, i.e., batteries 30f, 30g, 30h, 30i, and 30j, are disposed side by side in one line in the lowermost layer. In FIG. 6, one battery 30 in the middle of the uppermost layer, i.e., the battery 30c, and one battery 30 in the middle of the lowermost layer, i.e., the battery 30h, may correspond to a plurality of middle batteries disposed in the middle of the layers. In FIG. 6, four batteries 30 at two ends of the uppermost layer, i.e., the batteries 30a, 30b, 30d, and 30e, and four batteries 30 at two ends of the lowermost layer, i.e., the batteries 30f, 30g, 30i, and 30j, may correspond to a plurality of peripheral batteries that are not the middle batteries disposed in the middle of the layers.

The energization tab 50a and the heat dissipation sheet 60a may be disposed between an inner wall WL1 of the outer casing 10, which includes the lower casing 10a and the upper casing 10b, and the side plate part 41 of the holder 40a. The inner wall WL1 may be a part, of an inner wall of the outer casing 10 including the lower casing 10a and the upper casing 10b, that is opposed to the side plate part 41 of the holder 40a. The energization tab 50a may be disposed between the side plate part 41 of the holder 40a and the heat dissipation sheet 60a. The heat dissipation sheet 60a may be disposed between the inner wall WL1 of the outer casing 10, which includes the lower casing 10a and the upper casing 10b, and the energization tab 50a. The heat dissipation sheet 60a may be in contact with the inner wall WL1 of the outer casing 10 including the lower casing 10a and the upper casing 10b and in contact with the energization tab 50a. In an embodiment, the heat dissipation sheet 60a may be compressed by the inner wall WL1 of the outer casing 10 including the lower casing 10a and the upper casing 10b, as well as by the side plate part 41 of the holder 40a and the energization tab 50a.

The energization tab 50b and the heat dissipation sheet 60b may be disposed between an inner wall WL2 of the outer casing 10, which includes the lower casing 10a and the upper casing 10b, and the side plate part 41 of the holder 40b. The inner wall WL2 may be a part, of the inner wall of the outer casing 10 including the lower casing 10a and the upper casing 10b, that is opposed to the side plate part 41 of the holder 40b. The energization tab 50b may be disposed between the side plate part 41 of the holder 40b and the heat dissipation sheet 60b. The heat dissipation sheet 60b may be disposed between the inner wall WL2 of the outer casing 10, which includes the lower casing 10a and the upper casing 10b, and the energization tab 50b. The heat dissipation sheet 60b may be in contact with the inner wall WL2 of the outer casing 10 including the lower casing 10a and the upper casing 10b and in contact with the energization tab 50b. In an embodiment, the heat dissipation sheet 60b may be compressed by the inner wall WL2 of the outer casing 10 including the lower casing 10a and the upper casing 10b, as well as by the side plate part 41 of the holder 40b and the energization tab 50b. A part, of the inner wall WL1, that is opposed to the heat dissipation sheet 60a may have a flat surface. A part, of the inner wall WL2, that is opposed to the heat dissipation sheet 60b may have a flat surface.

FIG. 7 illustrates a sectional configuration example of a battery pack according to a comparative example. In the comparative example, the heat dissipation sheets 60a and 60b are not provided, and there are gaps between the inner wall WL1 of the outer casing 10 and the energization tab 50a and between the inner wall WL2 of the outer casing 10 and the energization tab 50b. In the battery pack according to the comparative example, heat generated by the batteries 30, i.e., the batteries 30a to 30j, may be easily built up in middle of the battery pack or at an uppermost layer of the battery pack. Therefore, in the battery pack according to the comparative example, for example, the three batteries 30 in the uppermost layer, i.e., the batteries 30b, 30c, and 30d, and the battery 30 in the middle of a lowermost layer, i.e., the battery 30h, become high heat generation batteries that generate heat to have a high temperature, as illustrated in FIG. 7. The four batteries 30, i.e., the batteries 30a, 30e, 30g, and 30i, adjacent to the above-described batteries 30 may become medium heat generation batteries that generate heat to have a medium temperature lower than the high temperature of the high heat generation batteries. The batteries 30 at the two ends of the lowermost layer, i.e., the batteries 30f and 30j, may become low heat generation batteries that generate heat to have a lowest temperature.

For example, a heat generation temperature of each of the batteries 30 included in the battery pack according to the comparative example illustrated in FIG. 7, i.e., the temperature of each of the batteries 30 at a time of heat generation of the batteries 30, may satisfy the following Expression (1).

Tc>Tb, Td, Th>Ta, Te, Tg, Ti>Tf, Tj . . . (1)

where:
Ta is a temperature of the battery 30a at the time of the energization;
Tb is a temperature of the battery 30b at the time of the energization;
Tc is a temperature of the battery 30c at the time of the energization;
Td is a temperature of the battery 30d at the time of the energization;
Te is a temperature of the battery 30e at the time of the energization;
Tf is a temperature of the battery 30f at the time of the energization;
Tg is a temperature of the battery 30g at the time of the energization;
Th is a temperature of the battery 30h at the time of the energization;
Ti is a temperature of the battery 30i at the time of the energization; and
Tj is a temperature of the battery 30j at the time of the energization.

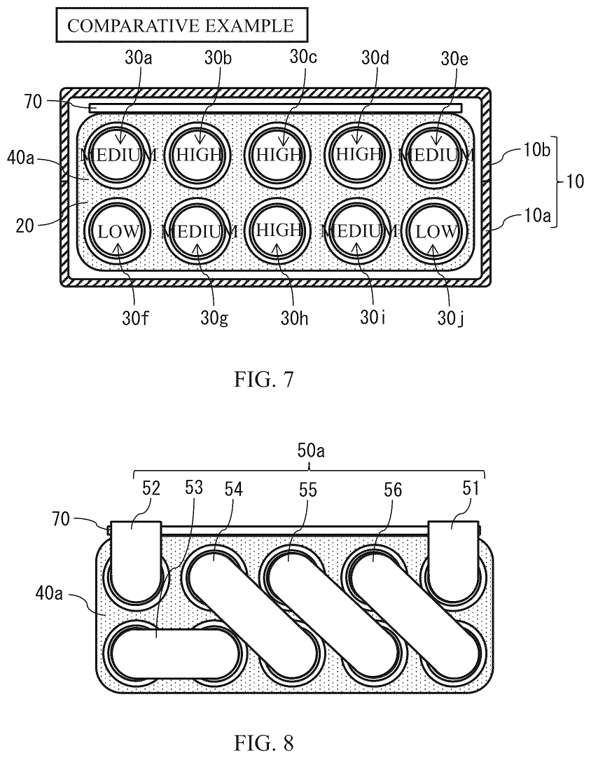

FIG. 8 illustrates a plan configuration example of the energization tab 50a. The energization tab 50a may include, for example, tabs 51 to 56, as illustrated in FIG. 8. The tab 51 may be coupled to a terminal of the battery 30e and the control board 70. The terminal of the battery 30e may be a negative electrode 32 of the battery 30e. The tab 52 may be coupled to a terminal of the battery 30a and the control board 70. The terminal of the battery 30a may be a positive electrode 31 of the battery 30a. The tab 53 may be coupled to a terminal of the battery 30f and a terminal of the battery 30g. The terminal of the battery 30f may be a negative electrode 32 of the battery 30f, and the terminal of the battery 30g may be a positive electrode 31 of the battery 30g. The tab 54 may be coupled to a terminal of the battery 30b and a terminal of the battery 30h. The terminal of the battery 30b may be a negative electrode 32 of the battery 30b, and the terminal of the battery 30h may be a positive electrode 31 of the battery 30h. The tab 55 may be coupled to a terminal of the battery 30c and a terminal of the battery 30i. The terminal of the battery 30c may be a negative electrode 32 of the battery 30c, and the terminal of the battery 30i may be a positive electrode 31 of the battery 30i. The tab 56 may be coupled to a terminal of the battery 30d and a terminal of the battery 30j. The terminal of the battery 30d may be a negative electrode 32 of the battery 30d, and the terminal of the battery 30j may be a positive electrode 31 of the battery 30j.

Each of the tabs 54, 55, and 56 may extend in an oblique direction with respect to the layers of the batteries 30 because of the layout of the batteries 30. The tab 53 may extend in a direction parallel to the lowermost layer of the batteries 30 because of the layout of the batteries 30. The tab 53 may have a length that is smaller than a length of each of the tabs 54, 55, and 56. Each of the tabs 51 to 56 may allow a current to flow therethrough and also allow heat generated by the battery 30 to propagate. Each of the tabs 51 to 56 may have an internal resistance. Therefore, each of the tabs 51 to 56 may generate heat due to the current flowing through corresponding one of the tabs 51 to 56. The heat generated by the tabs 51 to 56 may propagate to the batteries 30 coupled to the tabs 51 to 56.

The heat generated by the battery 30a may propagate to the heat dissipation sheet 60a via the tab 52. The heat generated by the battery 30b may propagate to the heat dissipation sheet 60a via the tab 54, and also to the battery 30h via the tab 54. The heat generated by the battery 30c may propagate to the heat dissipation sheet 60a via the tab 55, and also to the battery 30i via the tab 55. The heat generated by the battery 30d may propagate to the heat dissipation sheet 60a via the tab 56, and also to the battery 30j via the tab 56. The heat generated by the battery 30e may propagate to the heat dissipation sheet 60a via the tab 51. The heat generated by the battery 30f may propagate to the heat dissipation sheet 60a via the tab 53, and also to the battery 30g via the tab 53. The heat generated by the battery 30g may propagate to the heat dissipation sheet 60a via the tab 53, and also to the battery 30f via the tab 53. The heat generated by the battery 30h may propagate to the heat dissipation sheet 60a via the tab 54, and also to the battery 30b via the tab 54. The heat generated by the battery 30i may propagate to the heat dissipation sheet 60a via the tab 55, and also to the battery 30c via the tab 55. The heat generated by the battery 30j may propagate to the heat dissipation sheet 60a via the tab 56, and also to the battery 30d via the tab 56.

Each of the heat dissipation sheets 60a and 60b may serve, in the battery holder 40, to support the battery module 20 with corresponding one of the energization tabs 50a and 50b interposed therebetween. Each of the heat dissipation sheets 60a and 60b may also serve as a heat transfer path that allows heat generated by the batteries 30 in the battery holder 40 and corresponding one of the energization tabs 50a and 50b to propagate or to be released to the outer casing 10. Each of the heat dissipation sheets 60a and 60b may also serve as a heat transfer path that allows the heat generated by the batteries 30 in the battery holder 40 and corresponding one of the energization tabs 50a and 50b to propagate in an in-plane direction of corresponding one of the heat dissipation sheets 60a and 60b. Each of the heat dissipation sheets 60a and 60b may include a resin member having a heat transfer rate higher than that of a gas such as atmospheric air or nitrogen. Each of the heat dissipation sheets 60a and 60b may include, for example, an elastic porous resin member. Each of the heat dissipation sheets 60a and 60b may include, for example, a material such as urethane foam, polyethylene foam, ethylene-vinyl acetate (EVA) foam, or rubber sponge.

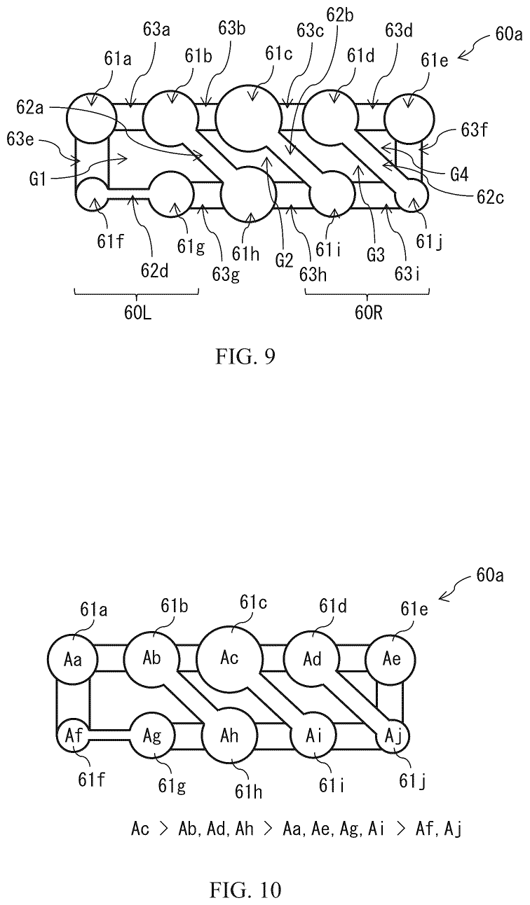

FIG. 9 illustrates a plan configuration example of the heat dissipation sheet 60a. The heat dissipation sheet 60a may have, for example, a member pattern corresponding to a layout of the respective terminals of the batteries 30 and a layout of the tabs 51 to 56, as illustrated in FIG. 9. The heat dissipation sheet 60b may have, for example, a member pattern corresponding to the layout of the respective terminals of the batteries 30 and a layout of the energization tab 50b. The member pattern may correspond to, for example, a layout in which the layout of the respective terminals of the batteries 30 and the layout of the energization tab 50b are combined with each other.

In an embodiment, the heat dissipation sheet 60a may include, for example, first heat dissipation parts 61 a to 61j, second heat dissipation parts 62 a to 62 d, and third heat dissipation parts 63a to 63i, as illustrated in FIG. 9. The heat dissipation sheet 60a may have, for example, gaps G1 to G4, as illustrated in FIG. 9. The gaps G1 to G4 may have a pattern corresponding to an inversion of the layout in which the layout of the respective terminals of the batteries 30 and the layout of the energization tab 50b are combined with each other. The first heat dissipation parts 61a to 61j may correspond to a specific but non-limiting example of “a plurality of first heat dissipation parts” in an embodiment of the present disclosure. The second heat dissipation parts 62a to 62d may correspond to a specific but non-limiting example of “a plurality of second heat dissipation parts” in an embodiment of the present disclosure. The third heat dissipation parts 63a to 63i may correspond to a specific but non-limiting example of “a plurality of third heat dissipation parts” in an embodiment of the present disclosure.

In an embodiment, each of the first heat dissipation parts 61a to 61j may be disposed at a position opposed to corresponding one of the terminals of the batteries 30. In an embodiment, each of the second heat dissipation parts 62a to 62d may be disposed at a position opposed to a part, of corresponding one of the tabs 51 to 56, that is not opposed to any of the terminals of the batteries 30. In an embodiment, each of the third heat dissipation parts 63a to 63i may be disposed at a position not opposed to any of the terminals of the batteries 30 and the tabs 51 to 56. In an embodiment, the first heat dissipation parts 61a to 61j, the second heat dissipation parts 62a to 62d, and the third heat dissipation parts 63a to 63i may form the above-described member pattern.

The first heat dissipation part 61a may be disposed at a position opposed to the terminal of the battery 30a. The first heat dissipation part 61b may be disposed at a position opposed to the terminal of the battery 30b. The first heat dissipation part 61c may be disposed at a position opposed to the terminal of the battery 30c. The first heat dissipation part 61d may be disposed at a position opposed to the terminal of the battery 30d. The first heat dissipation part 61e may be disposed at a position opposed to the terminal of the battery 30e. The first heat dissipation part 61f may be disposed at a position opposed to the terminal of the battery 30f. The first heat dissipation part 61g may be disposed at a position opposed to the terminal of the battery 30g. The first heat dissipation part 61h may be disposed at a position opposed to the terminal of the battery 30h. The first heat dissipation part 61i may be disposed at a position opposed to the terminal of the battery 30i. The first heat dissipation part 61j may be disposed at a position opposed to the terminal of the battery 30j. Each of the first heat dissipation parts 61a to 61j may have a shape the same as or substantially the same as the shape of the terminal of each of the batteries 30. For example, each of the first heat dissipation parts 61a to 61j may have a circular shape. In an embodiment, each of the first heat dissipation parts 61a to 61j may have a shape different from the circular shape.

The second heat dissipation part 62a may be disposed at a position opposed to a part, of the tab 54, that is not opposed to either of the respective terminals of the batteries 30b and 30h. The second heat dissipation part 62a may be coupled to the first heat dissipation parts 61b and 61h. The second heat dissipation part 62b may be disposed at a position opposed to a part, of the tab 55, that is not opposed to either of the respective terminals of the batteries 30c and 30i. The second heat dissipation part 62b may be coupled to the first heat dissipation parts 61c and 61i. The second heat dissipation part 62c may be disposed at a position opposed to a part, of the tab 56, that is not opposed to either of the respective terminals of the batteries 30d and 30j. The second heat dissipation part 62c may be coupled to the first heat dissipation parts 61d and 61j. The second heat dissipation part 62d may be disposed at a position opposed to a part, of the tab 53, that is not opposed to either of the respective terminals of the batteries 30f and 30g. The second heat dissipation part 62d may be coupled to the first heat dissipation parts 61f and 61g. Each of the second heat dissipation parts 62a to 62d may have, for example, a rectangular shape. In an embodiment, each of the second heat dissipation parts 62a to 62d may have a shape different from the rectangular shape.

The third heat dissipation part 63a may be disposed between the first heat dissipation part 61a and the first heat dissipation part 61b. The third heat dissipation part 63a may be coupled to the first heat dissipation parts 61a and 61b. The third heat dissipation part 63b may be disposed between the first heat dissipation part 61b and the first heat dissipation part 61c. The third heat dissipation part 63b may be coupled to the first heat dissipation parts 61b and 61c. The third heat dissipation part 63c may be disposed between the first heat dissipation part 61c and the first heat dissipation part 61d. The third heat dissipation part 63c may be coupled to the first heat dissipation parts 61c and 61d. The third heat dissipation part 63d may be disposed between the first heat dissipation part 61d and the first heat dissipation part 61e. The third heat dissipation part 63d may be coupled to the first heat dissipation parts 61d and 61e.

The third heat dissipation part 63e may be disposed at an edge of a left end part 60L of the heat dissipation sheet 60a. The third heat dissipation part 63e may be disposed between the first heat dissipation part 61a and the first heat dissipation part 61f. The third heat dissipation part 63e may be coupled to the first heat dissipation parts 61a and 61f. The third heat dissipation part 63f may be disposed at an edge of a right end part 60R of the heat dissipation sheet 60a. The third heat dissipation part 63f may be disposed between the first heat dissipation part 61e and the first heat dissipation part 61j. The third heat dissipation part 63f may be coupled to the first heat dissipation parts 61e and 61j.

The third heat dissipation part 63g may be disposed between the first heat dissipation part 61g and the first heat dissipation part 61h. The third heat dissipation part 63g may be coupled to the first heat dissipation parts 61g and 61h. The third heat dissipation part 63h may be disposed between the first heat dissipation part 61h and the first heat dissipation part 61i. The third heat dissipation part 63h may be coupled to the first heat dissipation parts 61h and 61i. The third heat dissipation part 63i may be disposed between the first heat dissipation part 61i and the first heat dissipation part 61j. The third heat dissipation part 63i may be coupled to the first heat dissipation parts 61i and 61j. Each of the third heat dissipation parts 63a to 63i may have, for example, a rectangular shape. In an embodiment, each of the third heat dissipation parts 63a to 63i may have a shape different from the rectangular shape.

FIG. 10 illustrates an example of an area of each of the first heat dissipation parts 61a to 61j. An area Aa of the first heat dissipation part 61a, an area Ab of the first heat dissipation part 61b, an area Ac of the first heat dissipation part 61c, an area Ad of the first heat dissipation part 61d, an area Ae of the first heat dissipation part 61e, an area Af of the first heat dissipation part 61f, an area Ag of the first heat dissipation part 61g, an area Ah of the first heat dissipation part 61h, an area Ai of the first heat dissipation part 61i, and an area Aj of the first heat dissipation part 61j may satisfy the following Expression (2). A large-and-small relationship between the areas Aa to Aj may coincide with a high-and-low relationship between the respective heat generation temperatures of the batteries 30 included in the battery pack according to the comparative example illustrated in FIG. 7. An amount of heat dissipated from each of the batteries 30, i.e., the batteries 30a to 30j, to the outer casing 10 via corresponding one of the first heat dissipation parts 61a to 61j may be adjusted by adjusting corresponding one of the areas Aa to Aj of the first heat dissipation parts 61a to 61j, based on the heat generation temperature of corresponding one of the batteries 30, i.e., the batteries 30a to 30j.

Ac>Ab, Ad, Ah>Aa, Ae, Ag, Ai>Af, Aj . . . (2)

Here, each of the batteries 30, i.e., the batteries 30c and 30h, disposed in the middle, of the batteries 30, i.e., the batteries 30a to 30j, may be referred to as a first battery. Each of the batteries 30, i.e., the batteries 30a, 30e, 30f, and 30j, disposed at corners, of the batteries 30, i.e., the batteries 30a to 30j, may be referred to as a second battery. In this case, each of the areas Ac and Ah of the first heat dissipation parts 61c and 61h opposed to the first batteries may be greater than each of the areas Aa, Ae, Af, and Aj of the first heat dissipation parts 61a, 61e, 61f, and 61j opposed to the second batteries.

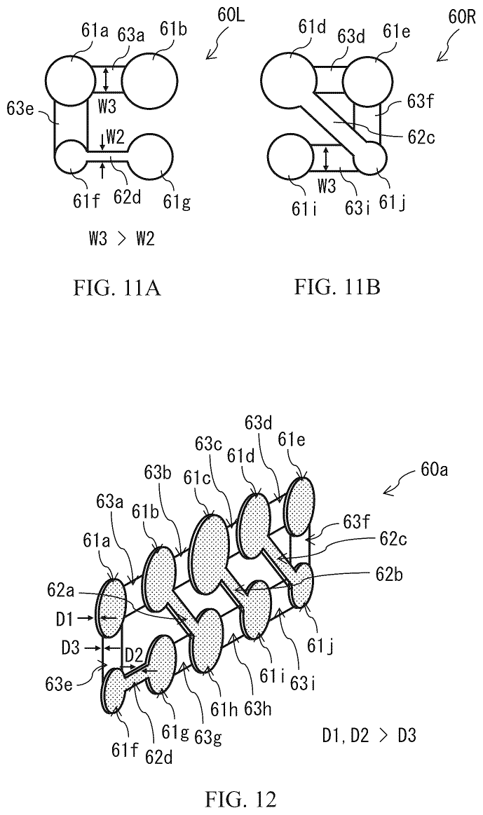

FIGS. 11A and 11B each illustrate a plan configuration example of each of the end parts of the heat dissipation sheet 60a in a longitudinal direction. FIG. 11A illustrates a plan configuration example of the left end part 60L of the heat dissipation sheet 60a in the longitudinal direction. FIG. 11B illustrates a plan configuration example of the right end part 60R of the heat dissipation sheet 60a in the longitudinal direction. The right end part 60R may correspond to a specific but non-limiting example of a “first end part” in an embodiment of the present disclosure. The left end part 60L may correspond to a specific but non-limiting example of a “second end part” in an embodiment of the present disclosure.

The left end part 60L may correspond to a part, of the heat dissipation sheet 60a, that is opposed to two or more peripheral batteries including the battery 30a and the batteries near the battery 30a, out of the batteries 30, i.e., the batteries 30a to 30j. The left end part 60L may include the first heat dissipation parts 61a, 61b, 61f, and 61g, the second heat dissipation part 62d, and the third heat dissipation parts 63a and 63e. The right end part 60R may correspond to a part, of the heat dissipation sheet 60a, that is opposed to two or more peripheral batteries including the battery 30e and the batteries near the battery 30e, out of the batteries 30, i.e., the batteries 30a to 30j. The right end part 60R may include the first heat dissipation parts 61d, 61e, 61i, and 61j, the second heat dissipation part 62c, and the third heat dissipation parts 63d, 63f, and 63i. In an embodiment, in the heat dissipation sheet 60a, a width W2 of a part having a smallest width in each of the second heat dissipation parts 62a to 62d may be smaller than a width W3 of a part having a smallest width in each of the third heat dissipation parts 63a to 63i.

In an embodiment, each of the tabs 51 to 56 may be configured to allow the temperature of each of the batteries 30 at the time of the energization to be higher than the temperature of each of the tabs 51 to 56 at the time of the energization. Accordingly, the tabs 51 to 56 may serve more as a heat transfer path than a heat dissipation source in relation to the batteries 30. Allowing the width W2 of each of the second heat dissipation parts 62a to 62d in contact with the tabs 53 to 56 to be smaller than the width W3 of each of the third heat dissipation parts 63a to 63i helps to prevent the heat of the tabs 53 to 56 from easily propagating to the outer casing 10 via the second heat dissipation parts 62a to 62d. For example, it helps to ensure, as much as possible, that the second heat dissipation parts 62a to 62d do not prevent the tabs 53 to 56 from serving as the heat transfer path. In addition, each of the third heat dissipation parts 63a to 63i not in contact with the tabs 51 to 56 may be coupled to corresponding two, of the first heat dissipation parts 61a to 61j, that do not share the same tab. This may allow each of the third heat dissipation parts 63a to 63i to serve as a heat transfer path between the corresponding two tabs of the tabs 51 to 56. Accordingly, an amount of heat transferred between the batteries 30 may be adjusted by the third heat dissipation parts 63a to 63i.

In an embodiment, the second heat dissipation part 62c at the right end part 60R may be longer than the second heat dissipation part 62d at the left end part 60L. In an embodiment, an area of the heat dissipation sheet 60a at the right end part 60R may be larger than an area of the heat dissipation sheet 60a at the left end part 60L by an amount based on a difference in length between the second heat dissipation part 62c and the second heat dissipation part 62d. Here, the tab 56 may be longer than the tab 53. An area of a part, of the tabs 51 to 56, that is opposed to the right end part 60R may be larger than an area of a part, of the tabs 51 to 56, that is opposed to the left end part 60L by an amount based on a difference in length between the tab 56 and the tab 53. Accordingly, an amount of heat dissipated from the part, of the tabs 51 to 56, that is opposed to the right end part 60R may be greater than an amount of heat dissipated from the part, of the tabs 51 to 56, that is opposed to the left end part 60L. An amount of heat dissipated from the tabs 51 to 56 to the outer casing 10 via the right end part 60R and an amount of heat dissipated from the tabs 51 to 56 to the outer casing 10 via the left end part 60L may be adjusted by allowing the area of the heat dissipation sheet 60a at the right end part 60R to be larger than the area of the heat dissipation sheet 60a at the left end part 60L.

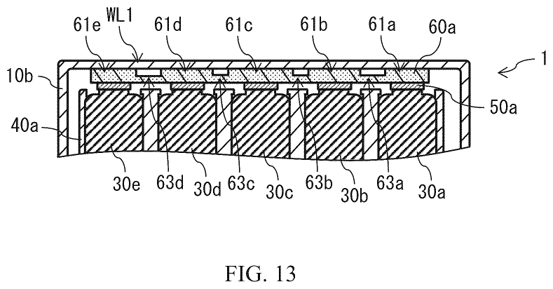

FIG. 12 illustrates a perspective configuration example of the heat dissipation sheet 60a. FIG. 13 illustrates a sectional configuration example of the battery pack 1. For example, a part of the heat dissipation sheet 60a may be in contact with the inner wall WL1 of the outer casing 10 including the lower casing 10a and the upper casing 10b, as illustrated in FIG. 13. In FIG. 12, the part, of the heat dissipation sheet 60a, that may be in contact with the inner wall WL1 is shaded for easier recognition of the part.

A surface of each of the first heat dissipation parts 61a to 61j and the second heat dissipation parts 62a to 62d may be in contact with the inner wall WL1. In contrast, a surface of each of the third heat dissipation parts 63a to 63i may be disposed away from the inner wall WL1 and not in contact with the inner wall WL1. In an embodiment, a thickness D3 of a part having a smallest thickness in each of the third heat dissipation parts 63a to 63i may be smaller than a thickness D2 of a part having a smallest thickness in each of the second heat dissipation parts 62a to 62d. In an embodiment, the thickness D3 of the part having the smallest thickness in each of the third heat dissipation parts 63a to 63i may be smaller than a thickness D1 of a part having a smallest thickness in each of the first heat dissipation parts 61a to 61j. In the heat dissipation sheet 60a, the third heat dissipation parts 63a to 63i may have a recessed shape, relative to the first heat dissipation parts 61a and 61j and the second heat dissipation parts 62a to 62d.

Each of the first heat dissipation parts 61a to 61j and the second heat dissipation parts 62a to 62d may be greater in thickness than each of the third heat dissipation parts 63a to 63i. Thus providing a difference between the thicknesses of each of the first heat dissipation parts 61a to 61j and the second heat dissipation parts 62a to 62d and the thickness of each of the third heat dissipation parts 63a to 63i reliably allows each of the first heat dissipation parts 61a to 61j and the second heat dissipation parts 62a to 62d to be in close contact with the inner wall WL1, and also reliably allows each of the third heat dissipation parts 63a to 63i to be away from the inner wall WL1. Accordingly, heat generated in a part, of the tabs 51 to 56, that is in contact with the first heat dissipation parts 61a to 61j and the second heat dissipation parts 62a to 62d and in each of the batteries 30, i.e., the batteries 30a to 30j, is efficiently dissipated to the outer casing 10 via the first heat dissipation parts 61a to 61j and the second heat dissipation parts 62a to 62d. This helps to suppress an increase in temperature of the part, of the tabs 51 to 56, that is in contact with the first heat dissipation parts 61a to 61j and the second heat dissipation parts 62a to 62d, and of each of the batteries 30, i.e., the batteries 30a to 30j.

Next, example effects of the battery pack 1 will be described.

Electronic equipment has been widely used. Such widespread use has promoted development of a battery as a power source that is to be applied to the electronic equipment. In relation to this, a battery pack including a plurality of batteries has been proposed to easily and safely handle the batteries. A technique related to a configuration of the battery pack has been considered in various ways. For example, JP-A No. 2016-569129 discloses a technique of dissipating heat built up inside the battery pack to an outside of the battery pack via a heat dissipation member. However, JP-A No. 2016-569129 does not take into consideration heat generation by an energization tab upon current application to the batteries included in the battery pack, or an influence of heat transfer by the energization tab. It is therefore difficult to reduce variations in temperature between the batteries in the battery pack. Such variations in temperature between the batteries in the battery pack can lead to variations in characteristic or lifetime between the batteries.

In contrast, according to the present example embodiment, the energization tabs 50a and 50b and the heat dissipation sheets 60a and 60b may be provided between the respective terminals of the batteries 30 and the inner wall of the outer casing 10. This allows a part of heat generated by the batteries 30 in the outer casing 10 to propagate to the outer casing 10 via the energization tabs 50a and 50b and the heat dissipation sheets 60a and 60b. A part of the heat generated by one or more of the batteries 30, e.g., the first batteries, may propagate to one or more of the rest of the batteries 30, e.g., the second batteries, via the energization tabs 50a and 50b coupled to the first batteries. Each of the energization tabs 50a and 50b may have the internal resistance. Therefore, each of the energization tabs 50a and 50b may generate heat due to a current flowing through corresponding one of the energization tabs 50a and 50b. A part of the heat generated by the energization tabs 50a and 50b may propagate to the batteries 30 coupled to the energization tabs 50a and 50b. Therefore, the heat generation distribution of the batteries 30 may depend on the layout of the respective terminals of the batteries 30 and the layout of the energization tabs 50a and 50b. According to an embodiment of the present disclosure, the heat dissipation sheet 60a has the member pattern corresponding to the layout of the respective terminals of the batteries 30 and the layout of the energization tab 50a. This helps to reduce unevenness of the heat generation distribution of the batteries 30 by the heat dissipation sheet 60a having the member pattern.

Note that when the heat dissipation sheet has a flat plate shape with no pattern, the heat generation distribution of the batteries 30 is not so different from that in a battery pack with no heat dissipation sheet. Therefore, the heat dissipation sheet having the flat plate shape with no pattern has a smaller effect of reducing the unevenness of the heat generation distribution of the batteries 30. Accordingly, when the heat dissipation sheet 60a having the member pattern is provided, a heat generation distribution of the batteries 30 may be more even, as compared with when no heat dissipation sheet is provided or when the heat dissipation sheet having the flat plate shape with no pattern is provided. It is thus possible to help to reduce a possibility of the batteries 30 varying in characteristic or lifetime.

In an embodiment, the heat dissipation sheet 60a may include the first heat dissipation parts 61a to 61j, the second heat dissipation parts 62a to 62d, and the third heat dissipation parts 63a to 63i. In an embodiment, the first heat dissipation parts 61a to 61j, the second heat dissipation parts 62a to 62d, and the third heat dissipation parts 63a to 63i may form the member pattern described above. This helps to reduce the unevenness of the heat generation distribution of the batteries 30 by the heat dissipation sheet 60a having the member pattern described above. In this case, the heat generation distribution of the batteries 30 may be more even, as compared with when no heat dissipation sheet is provided or when the heat dissipation sheet having the flat plate shape with no pattern is provided. It is thus possible to help to reduce the possibility of the batteries 30 varying in characteristic or lifetime.

In an embodiment, each of the tabs 51 to 56 may be configured to allow the temperature of each of the batteries 30 at the time of the energization to be higher than the temperature of each of the tabs 51 to 56 at the time of the energization. Accordingly, the tabs 51 to 56 may serve more as the heat transfer path than the heat dissipation source in relation to the batteries 30. Further, in an embodiment, the width W2 of each of the second heat dissipation parts 62a to 62d in contact with the tabs 53 to 56 may be smaller than the width W3 of each of the third heat dissipation parts 63a to 63i. This helps to prevent the heat of the tabs 53 to 56 from easily propagating to the outer casing 10 via the second heat dissipation parts 62a to 62d. For example, it helps to ensure, as much as possible, that the second heat dissipation parts 62a to 62d do not prevent the tabs 53 to 56 from serving as the heat transfer path. In this case, the heat generation distribution of the batteries 30 may be more even, as compared with when the respective widths of the tabs 51 to 56 are not adjusted as described above. It is thus possible to help to reduce the possibility of the batteries 30 varying in characteristic or lifetime.

In an embodiment, the thickness D3 of the part having the smallest thickness in each of the third heat dissipation parts 63a to 63i may be smaller than the thickness D1 of the part having the smallest thickness in each of the first heat dissipation parts 61a to 61j and the thickness D2 of the part having the smallest thickness in each of the second heat dissipation parts 62a to 62d. In an embodiment, each of the first heat dissipation parts 61a to 61j and the second heat dissipation parts 62a to 62d may be in contact with the outer casing 10, and at least the part having the smallest thickness in each of the third heat dissipation parts 63a to 63i may not be in contact with the outer casing 10. Here, each of the third heat dissipation parts 63a to 63i not in contact with the tabs 51 to 56 may be coupled to corresponding two, of the first heat dissipation parts 61a to 61j, that do not share the same tab. This may allow each of the third heat dissipation parts 63a to 63i to serve as the heat transfer path between the corresponding two tabs of the tabs 51 to 56. Accordingly, the amount of the heat transferred between the batteries 30 may be adjusted by the third heat dissipation parts 63a to 63i. In this case, the heat generation distribution of the batteries 30 may be more even, as compared with when no heat dissipation sheet is provided or when the heat dissipation sheet having the flat plate shape with no pattern is provided. It is thus possible to help to reduce the possibility of the batteries 30 varying in characteristic or lifetime.

Each of the batteries 30, i.e., the batteries 30c and 30h, disposed in the middle, of the batteries 30, i.e., the batteries 30a to 30j, may be referred to as the first battery. Each of the batteries 30, i.e., the batteries 30a, 30e, 30f, and 30j, disposed at the corners, of the batteries 30, i.e., the batteries 30a to 30j, may be referred to as the second battery. In an embodiment, each of the areas Ac and Ah of the first heat dissipation parts 61c and 61h opposed to the first batteries may be larger than each of the areas Aa, Ae, Af, and Aj of the first heat dissipation parts 61a, 61e, 61f, and 61j opposed to the second batteries. This allows an amount of heat dissipated from each of the first heat dissipation parts 61a to 61j to be adjusted based on the heat generation temperature of the batteries 30, i.e., the batteries 30a to 30j. This, in turn, allows for adjustment of an amount of heat dissipated from the batteries 30, i.e., the batteries 30a to 30j, to the outer casing 10 via each of the first heat dissipation parts 61a to 61j. In this case, the heat generation distribution of the batteries 30 may be more even, as compared with when no heat dissipation sheet is provided or when the heat dissipation sheet having the flat plate shape with no pattern is provided. It is thus possible to help to reduce the possibility of the batteries 30 varying in characteristic or lifetime.

In an embodiment, the second heat dissipation part 62c at the right end part 60R may be longer than the second heat dissipation part 62d at the left end part 60L. In an embodiment, the area of the heat dissipation sheet 60a at the right end part 60R may be larger than the area of the heat dissipation sheet 60a at the left end part 60L by the amount based on the difference in length between the second heat dissipation part 62c and the second heat dissipation part 62d. Here, the tab 56 may be longer than the tab 53. The area of the part, of the tabs 51 to 56, that is opposed to the right end part 60R may be larger than the area of the part, of the tabs 51 to 56, that is opposed to the left end part 60L by the amount based on the difference in length between the tab 56 and the tab 53. Accordingly, the amount of heat dissipated from the part, of the tabs 51 to 56, that is opposed to the right end part 60R may be greater than the amount of heat dissipated from the part, of the tabs 51 to 56, that is opposed to the left end part 60L. The amount of heat dissipated from the tabs 51 to 56 to the outer casing 10 via the right end part 60R and the amount of heat dissipated from the tabs 51 to 56 to the outer casing 10 via the left end part 60L may be adjusted by allowing the area of the heat dissipation sheet 60a at the right end part 60R to be larger than the area of the heat dissipation sheet 60a at the left end part 60L. In this case, the heat generation distribution of the batteries 30 may be more even, as compared with when no heat dissipation sheet is provided or when the heat dissipation sheet having the flat plate shape with no pattern is provided. It is thus possible to help to reduce the possibility of the batteries 30 varying in characteristic or lifetime.

A description is given next of modification examples of the battery pack 1 according to an embodiment of the present disclosure.

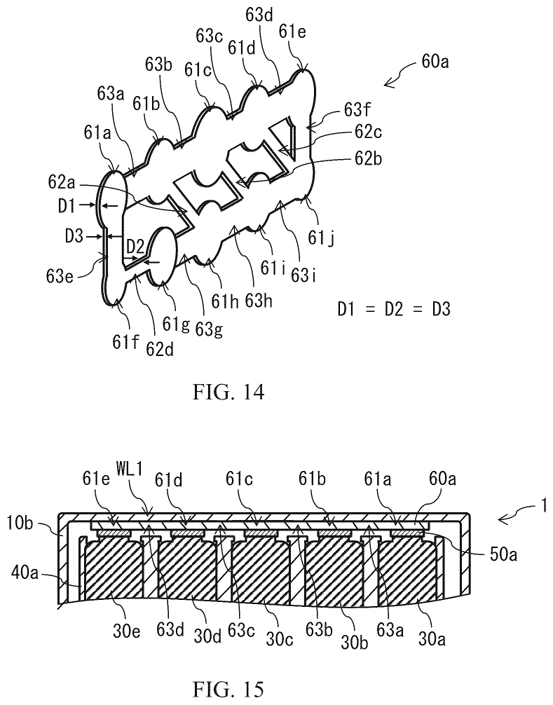

FIG. 14 illustrates a modification example of the perspective configuration of the heat dissipation sheet 60a. FIG. 15 illustrates a sectional configuration example of the battery pack 1 including the heat dissipation sheet 60a illustrated in FIG. 14. In an embodiment, the thickness of the heat dissipation sheet 60a may be uniform or substantially uniform at any part of the heat dissipation sheet 60a in the example embodiment described above. In this case, the heat dissipation sheet 60a may satisfy the following: D1=D2=D3. In the present modification example, the surfaces of the first heat dissipation parts 61a to 61j, the surfaces of the second heat dissipation parts 62a to 62d, and the surfaces of the third heat dissipation parts 63a to 63i may be in contact with the inner wall WL1 of the outer casing 10 including the lower casing 10a and the upper casing 10b. In this case also, it is possible to help to reduce the possibility of the batteries 30 varying in characteristic or lifetime, by adjusting, for example, the areas of the first heat dissipation parts 61a to 61j, the widths of the second heat dissipation parts 62a to 62d, and the widths of the third heat dissipation parts 63a to 63i.

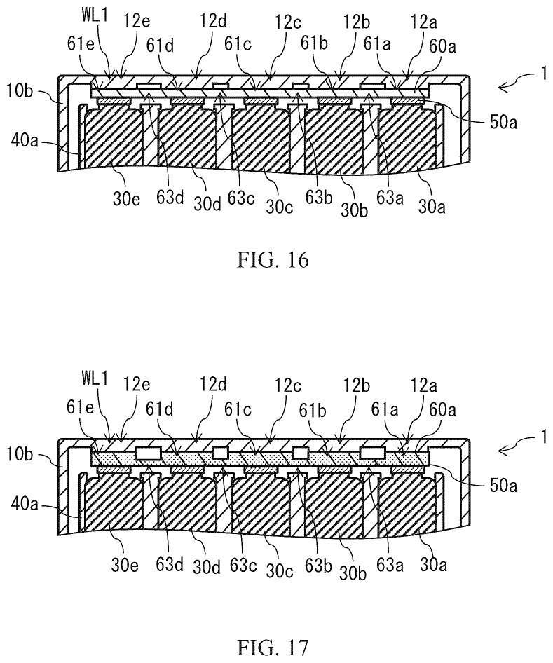

FIG. 16 illustrates a modification example of the sectional configuration of the battery pack 1 including the heat dissipation sheet 60a illustrated in FIG. 14. In the present modification example, the inner wall WL1 of the outer casing 10 including the lower casing 10a and the upper casing 10b may include a protrusion 12 at a position opposed to each of the first heat dissipation parts 61a to 61j and the second heat dissipation parts 62a to 62d. In an embodiment, each of the first heat dissipation parts 61a to 61j and the second heat dissipation parts 62a to 62d may be in contact with corresponding one of the protrusions 12.

FIG. 16 illustrates an example in which a protrusion 12a is provided at a position opposed to the first heat dissipation part 61a, a protrusion 12b is provided at a position opposed to the first heat dissipation part 61b, a protrusion 12c is provided at a position opposed to the first heat dissipation part 61c, a protrusion 12d is provided at a position opposed to the first heat dissipation part 61d, and a protrusion 12e is provided at a position opposed to the first heat dissipation part 61e. FIG. 16 illustrates an example in which, in addition to the above, the first heat dissipation part 61a is in contact with the protrusion 12a, the first heat dissipation part 61b is in contact with the protrusion 12b, the first heat dissipation part 61c is in contact with the protrusion 12c, the first heat dissipation part 61d is in contact with the protrusion 12d, and the first heat dissipation part 61e is in contact with the protrusion 12e.

In an embodiment, all or a part of each of the third heat dissipation parts 63a to 63i may not be in contact with the inner wall WL1 of the outer casing 10 including the lower casing 10a and the upper casing 10b in the present modification example. FIG. 16 illustrates an example in which all of the respective surfaces of the third heat dissipation parts 63a to 63i are not in contact with the inner wall WL1 of the outer casing 10 including the lower casing 10a and the upper casing 10b.

As described above, in the present modification example, the third heat dissipation parts 63a to 63i may not be in contact with the tabs 51 to 56 and the inner wall WL1. This may allow each of the third heat dissipation parts 63a to 63i to serve as the heat transfer path between the corresponding two tabs of the tabs 51 to 56. Accordingly, the amount of the heat transferred between the batteries 30 may be adjusted by the third heat dissipation parts 63a to 63i. In this case, the heat generation distribution of the batteries 30 may be more even. It is thus possible to help to reduce the possibility of the batteries 30 varying in characteristic or lifetime.

FIG. 17 illustrates a modification example of the sectional configuration of the battery pack 1 including the heat dissipation sheet 60a illustrated in FIG. 12. In the present modification example, the inner wall WL1 of the outer casing 10 including the lower casing 10a and the upper casing 10b may include the protrusion 12 at the position opposed to each of the first heat dissipation parts 61a to 61j and the second heat dissipation parts 62a to 62d. In an embodiment, each of the first heat dissipation parts 61a to 61j and the second heat dissipation parts 62a to 62d may be in contact with corresponding one of the protrusions 12.

FIG. 17 illustrates an example in which the protrusion 12a is provided at the position opposed to the first heat dissipation part 61a, the protrusion 12b is provided at the position opposed to the first heat dissipation part 61b, the protrusion 12c is provided at the position opposed to the first heat dissipation part 61c, the protrusion 12d is provided at the position opposed to the first heat dissipation part 61d, and the protrusion 12e is provided at the position opposed to the first heat dissipation part 61e. FIG. 17 illustrates an example in which, in addition to the above, the first heat dissipation part 61a is in contact with the protrusion 12a, the first heat dissipation part 61b is in contact with the protrusion 12b, the first heat dissipation part 61c is in contact with the protrusion 12c, the first heat dissipation part 61d is in contact with the protrusion 12d, and the first heat dissipation part 61e is in contact with the protrusion 12e.

In an embodiment, all or a part of each of the third heat dissipation parts 63a to 63i may not be in contact with the inner wall WL1 of the outer casing 10 including the lower casing 10a and the upper casing 10b in the present modification example. FIG. 17 illustrates an example in which all of the respective surfaces of the third heat dissipation parts 63a to 63i are not in contact with the inner wall WL1 of the outer casing 10 including the lower casing 10a and the upper casing 10b.

As described above, in the present modification example, the third heat dissipation parts 63a to 63i may not be in contact with the tabs 51 to 56 and the inner wall WL1. This may allow each of the third heat dissipation parts 63a to 63i to serve as the heat transfer path between the corresponding two tabs of the tabs 51 to 56. For example, the amount of the heat transferred between the batteries 30 may be adjusted by the third heat dissipation parts 63a to 63i. In this case, the heat generation distribution of the batteries 30 may be more even. It is thus possible to help to reduce the possibility of the batteries 30 varying in characteristic or lifetime.

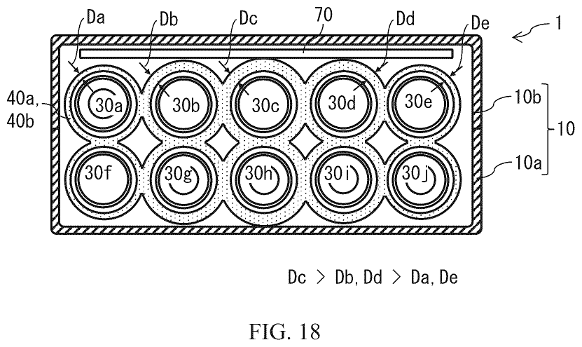

FIG. 18 illustrates a modification example of the sectional configuration of the battery pack 1 according to any of the example embodiment and the modification examples thereof described above. In the battery pack 1 according to the present modification example, for example, a thickness of a part, of the battery holder 40, that surrounds a peripheral surface of the first battery described above may be larger than a thickness of a part, of the battery holder 40, that surrounds a peripheral surface of the second battery described above, as illustrated in FIG. 18.

Thicknesses, i.e., thicknesses Da to De, of respective parts of the battery holder 40, that respectively surround peripheral surfaces of the batteries 30a to 30e may satisfy, for example, the following Expression (3).

Dc>Db, Dd>Da, De . . . (3)

where:
Da is the thickness of the part that surrounds the peripheral surface of the battery 30a;
Db is the thickness of the part that surrounds the peripheral surface of the battery 30b;
Dc is the thickness of the part that surrounds the peripheral surface of the battery 30c;
Dd is the thickness of the part that surrounds the peripheral surface of the battery 30d; and
De is the thickness of the part that surrounds the peripheral surface of the battery 30e.

The thickness of the battery holder 40 may be proportional to a heat capacity of the battery holder 40. Increasing the thickness, e.g., the thickness Dc, of the part, of the battery holder 40, that surrounds the peripheral surface of the first battery described above may increase a heat capacity of the part, of the battery holder 40, that surrounds the peripheral surface of the first battery described above. This helps to suppress an increase in temperature of the part, of the battery holder 40, that surrounds the peripheral surface of the first battery described above, and of the first battery described above.

In the present modification example, the thickness of the part, of the battery holder 40, that surrounds the peripheral surface of the first battery described above may thus be larger than the thickness of the part, of the battery holder 40, that surrounds the peripheral surface of the second battery described above. This helps to suppress an increase in temperature of the part, of the battery holder 40, that surrounds the peripheral surface of the first battery described above, and of the first battery described above. In this case, the heat generation distribution of the batteries 30 may be more even. It is thus possible to help to reduce the possibility of the batteries 30 varying in characteristic or lifetime.

Next, example effects of Examples 1, 2, and 3 will be described in comparison with those of Comparative examples 1 and 2 according to an embodiment.

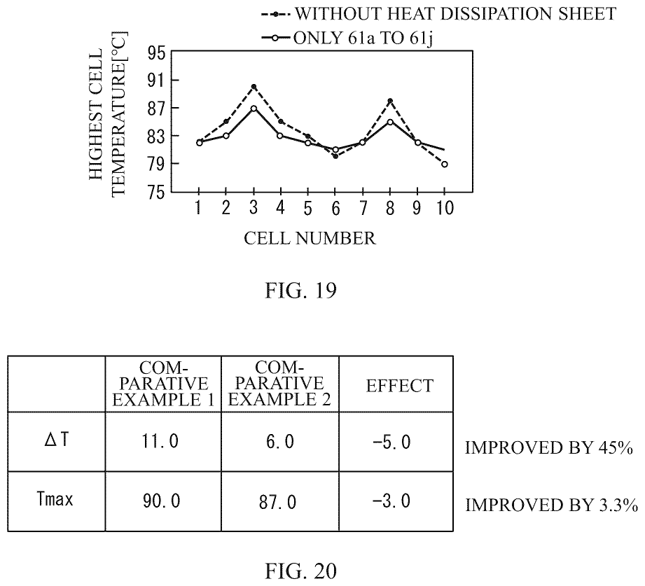

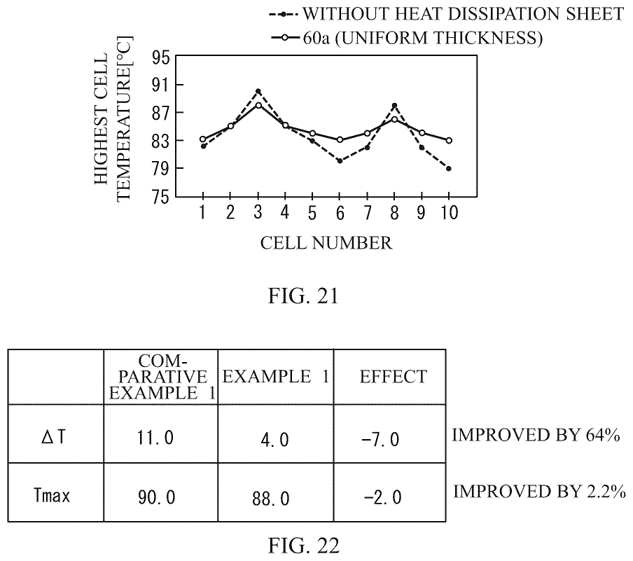

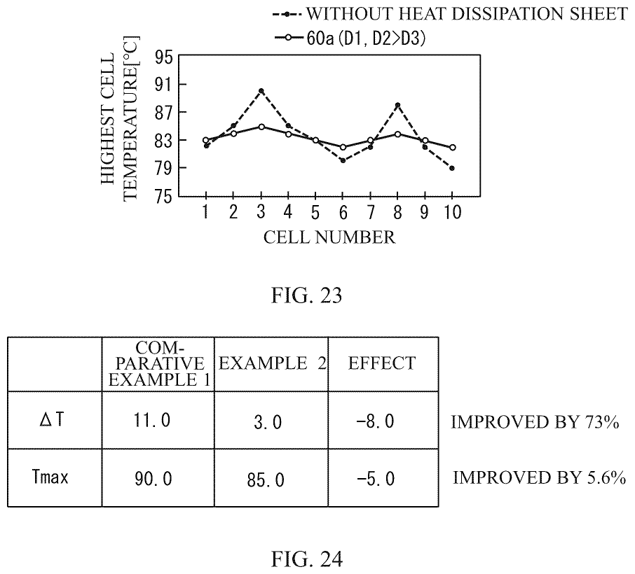

FIG. 19 illustrates a heat generation distribution of the batteries 30 in a battery pack according to each of Comparative examples 1 and 2. FIG. 20 describes, with numerical values, the heat generation distributions illustrated in FIG. 19. FIG. 21 illustrates a heat generation distribution of the batteries 30 in a battery pack according to Example 1 and the heat generation distribution of the batteries 30 in the battery pack according to Comparative example 1. FIG. 22 describes, with numerical values, the heat generation distributions illustrated in FIG. 21. FIG. 23 illustrates a heat generation distribution of the batteries 30 in a battery pack according to Example 2 and the heat generation distribution of the batteries 30 in the battery pack according to Comparative example 1. FIG. 24 describes, with numerical values, the heat generation distributions illustrated in FIG. 23. FIG. 25 illustrates a heat generation distribution of the batteries 30 in a battery pack according to Example 3 and the heat generation distribution of the batteries 30 in the battery pack according to Comparative example 1. FIG. 26 describes, with numerical values, the heat generation distributions illustrated in FIG. 25. In each of Comparative examples 1 and 2 and Examples 1, 2, and 3, for example, five batteries 30, i.e., the batteries 30a, 30b, 30c, 30d, and 30e, were disposed side by side in one line in the uppermost layer, and another five batteries 30, i.e., the batteries 30f, 30g, 30h, 30i, and 30j, were disposed side by side in one line in the lowermost layer in the battery pack, as illustrated in FIGS. 6 and 7.

In Comparative example 1, no heat dissipation sheet was provided. In Comparative example 2, a heat dissipation member including the first heat dissipation parts 61 a to 61 j was provided. In Example 1, the thickness of the heat dissipation sheet 60 a was uniform or substantially uniform at any location. In Example 2, the thickness of the heat dissipation sheet 60a satisfied D1 >D2 >D3, and the inner wall WL1 of the outer casing 10 was a flat surface. In Example 3, the thickness of the heat dissipation sheet 60 a satisfied D1 >D2 >D3, and the inner wall WL1 of the outer casing 10 was provided with the protrusions 12.

FIGS. 19 and 20 revealed that the provision of the heat dissipation member including the first heat dissipation parts 61a to 61j improved a difference ΔT between an upper limit value and a lower limit value in the heat generation distribution of the batteries 30 by 45%, and improved the upper limit value of the heat generation distribution of the batteries 30 by 3.3%, as compared with a case where no heat dissipation sheet was provided. FIGS. 21 and 22 revealed that the provision of the heat dissipation sheet 60a having the thickness uniform at any location improved the difference ΔT between the upper limit value and the lower limit value in the heat generation distribution of the batteries 30 by 64%, and improved the upper limit value of the heat generation distribution of the batteries 30 by 2.2%, as compared with the case where no heat dissipation sheet was provided.

FIGS. 23 and 24 revealed that the provision of the heat dissipation sheet 60a having the thickness that satisfied D1 >D2 >D3 improved the difference ΔT between the upper limit value and the lower limit value in the heat generation distribution of the batteries 30 by 73%, and improved the upper limit value of the heat generation distribution of the batteries 30 by 5.6%, as compared with the case where no heat dissipation sheet was provided. FIGS. 25 and 26 revealed that the provision of the heat dissipation sheet 60 a having the thickness that satisfied D1>D2>D3 and the protrusions 12 on the inner wall WL1 of the outer casing 10 improved the difference ΔT between the upper limit value and the lower limit value in the heat generation distribution of the batteries 30 by 95%, and improved the upper limit value of the heat generation distribution of the batteries 30 by 8.3%, as compared with the case where no heat dissipation sheet was provided.

Next, a description will be given of a modification example common to the example embodiment and the modification examples thereof described above according to an embodiment.

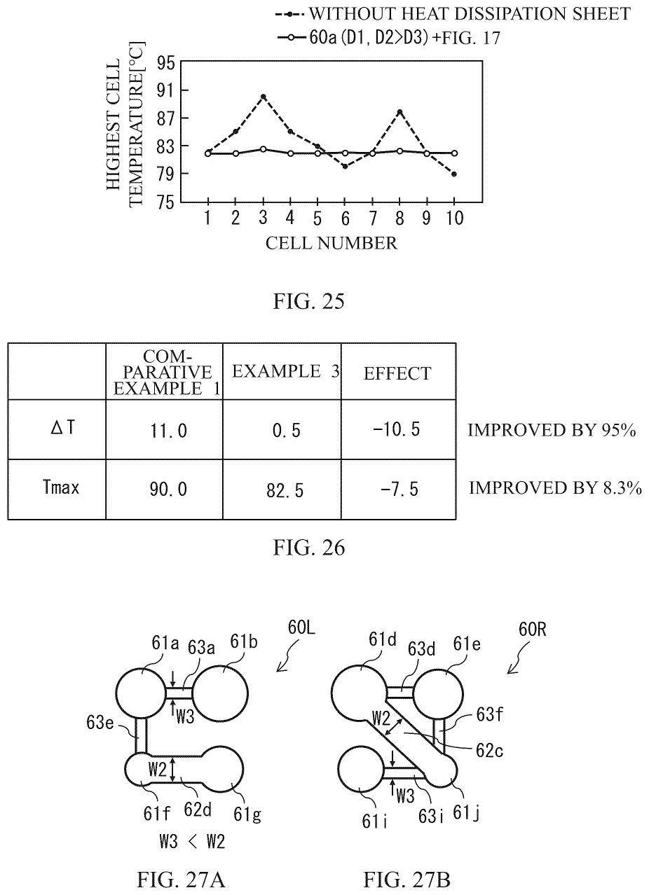

FIG. 27A illustrates a modification example of the plan configuration of the left end part 60L of the heat dissipation sheet 60a. FIG. 27B illustrates a modification example of the plan configuration of the right end part 60R of the heat dissipation sheet 60a. In the present modification example, each of the tabs 51 to 56 may be configured to allow the temperature of each of the batteries 30 at the time of the energization to be lower than the temperature of each of the tabs 51 to 56 at the time of the energization. In an embodiment, each of the tabs 51 to 56 may include, for example, Al or Ni. Al may have a volume resistivity of, for example, 60 IACS %. Ni may have a volume resistivity of, for example, 25 IACS %. Note that “IACS %” may indicate a value representing a ratio based on a volume resistivity of standard annealed copper, i.e., 1.7241×10⁻² μΩm, as 100 IACS %.

In the present modification example, the tabs 51 to 56 may serve more as the heat dissipation source than the heat transfer path in relation to the batteries 30. Allowing the width W2 of each of the second heat dissipation parts 62a to 62d in contact with the tabs 53 to 56 to be larger than the width W3 of each of the third heat dissipation parts 63a to 63i helps to allow the heat of the tabs 53 to 56 to easily propagate to the outer casing 10 via the second heat dissipation parts 62a to 62d. For example, the tabs 53 to 56 may serve as the heat dissipation source. In addition, each of the third heat dissipation parts 63a to 63i not in contact with the tabs 51 to 56 may be coupled to corresponding two, of the first heat dissipation parts 61a to 61j, that do not share the same tab. This may allow the third heat dissipation parts 63a to 63i to serve as the heat transfer path between the two tabs of the tabs 51 to 56. For example, the amount of heat transferred between the batteries 30 may be adjusted by the third heat dissipation parts 63a to 63i.

In the present modification example, the second heat dissipation part 62c at the right end part 60R may be longer than the second heat dissipation part 62d at the left end part 60L. In an embodiment, the area of the heat dissipation sheet 60a at the right end part 60R may be larger than the area of the heat dissipation sheet 60a at the left end part 60L by the amount based on the difference in length between the second heat dissipation part 62c and the second heat dissipation part 62d. Here, the tab 56 may be longer than the tab 53. The area of the part, of the tabs 51 to 56, that is opposed to the right end part 60R may be larger than the area of the part, of the tabs 51 to 56, that is opposed to the left end part 60L by the amount based on the difference in length between the tab 56 and the tab 53. Accordingly, the amount of heat dissipated from the part, of the tabs 51 to 56, that is opposed to the right end part 60R may be greater than the amount of heat dissipated from the part, of the tabs 51 to 56, that is opposed to the left end part 60L. The amount of heat dissipated from the tabs 51 to 56 to the outer casing 10 via the right end part 60R and the amount of heat dissipated from the tabs 51 to 56 to the outer casing 10 via the left end part 60L may be adjusted by allowing the area of the heat dissipation sheet 60a at the right end part 60R to be larger than the area of the heat dissipation sheet 60a at the left end part 60L.

In the present modification embodiment, each of the tabs 51 to 56 may be configured to allow the temperature of each of the batteries 30 at the time of the energization to be lower than the temperature of each of the tabs 51 to 56 at the time of the energization. Accordingly, the tabs 51 to 56 may serve more as the heat dissipation source than the heat transfer path in relation to the batteries 30. Further, in the present modification example, the width W2 of each of the second heat dissipation parts 62a to 62d in contact with the tabs 53 to 56 may be larger than the width W3 of each of the third heat dissipation parts 63a to 63i. This helps to allow the heat of the tabs 53 to 56 to easily propagate to the outer casing 10 via the second heat dissipation parts 62a to 62d. Accordingly, the tabs 53 to 56 may serve as the heat dissipation source. In this case, the heat generation distribution of the batteries 30 may be more even, as compared with when the respective widths of the tabs 51 to 56 are not adjusted as described above. It is thus possible to help to reduce the possibility of the batteries 30 varying in characteristic or lifetime.

Although the present disclosure has been described hereinabove with reference to some example embodiments and the modification examples thereof, the present disclosure is not limited to the examples described in the above-described example embodiments and the modification examples thereof, and various modifications can be made to the present disclosure. The effects described herein are mere examples, and effects of the present disclosure are therefore not limited to those described herein. Accordingly, an embodiment of the present disclosure may achieve any other effect.

Furthermore, the present disclosure encompasses any possible combination of some or all of the various embodiments and the modification examples described herein and incorporated herein. The following configurations are provided according to an embodiment of the present disclosure.

(1)

A battery pack including:
a plurality of batteries each including a terminal;
a plurality of energization tabs coupled to the respective terminals of the batteries;
a heat dissipation sheet in contact with the energization tabs; and
a housing that houses the batteries, the energization tabs, and the heat dissipation sheet and is in contact with the heat dissipation sheet, in which
the heat dissipation sheet has a member pattern corresponding to a layout of the respective terminals of the batteries and a layout of the energization tabs.
   (2)

The battery pack according to (1), in which
the heat dissipation sheet includes
   a plurality of first heat dissipation parts each disposed at a position opposed to corresponding one of the terminals,
   a plurality of second heat dissipation parts each disposed at a position opposed to a part, of corresponding one of the energization tabs, that is not opposed to any of the terminals, and
   a plurality of third heat dissipation parts each disposed at a position not opposed to any of the terminals and the energization tabs, and
the first heat dissipation parts, the second heat dissipation parts, and the third heat dissipation parts form the member pattern.
   (3)

The battery pack according to (2), in which each of the energization tabs is configured to allow a temperature of each of the batteries at a time of energization to be higher than a temperature of each of the energization tabs at the time of the energization.

(4)

The battery pack according to (2), in which each of the energization tabs includes Cu.

(5)

The battery pack according to (3) or (4), in which a width of a part having a smallest width in each of the second heat dissipation parts is smaller than a width of a part having a smallest width in each of the third heat dissipation parts.

(6)

The battery pack according to (2), in which each of the energization tabs is configured to allow a temperature of each of the batteries at a time of energization to be lower than a temperature of each of the energization tabs at the time of the energization.

(7)

The battery pack according to (2), in which each of the energization tabs includes Al or Ni.

(8)

The battery pack according to (6) or (7), in which a width of a part having a smallest width in each of the second heat dissipation parts is larger than a width of a part having a smallest width in each of the third heat dissipation parts.

(9)

The battery pack according to any one of (2) to (8), in which a thickness of a part having a smallest thickness in each of the third heat dissipation parts is smaller than a thickness of a part having a smallest thickness in each of the first heat dissipation parts and the second heat dissipation parts.

(10)

The battery pack according to (9), in which
each of the first heat dissipation parts and the second heat dissipation parts is in contact with the housing, and
at least the part having the smallest thickness in each of the third heat dissipation parts is not in contact with the housing.
   (11)

The battery pack according to any one of (2) to (10), in which an area of the first heat dissipation part opposed to the terminal of a first battery is larger than an area of the first heat dissipation part opposed to the terminal of a second battery, where the first battery is one of the batteries that is disposed in middle, and the second battery is one of the batteries that is disposed at a corner.

(12)

The battery pack according to (11), in which
the heat dissipation sheet includes a first end part and a second end part,
each of the first end part and the second end part includes one or more of the first heat dissipation parts, one or more of the second heat dissipation parts, and one or more of the third heat dissipation parts,
each of the one or more second heat dissipation parts at the first end part is longer than each of the one or more second heat dissipation parts at the second end part, and
an area of the heat dissipation sheet at the first end part is larger than an area of the heat dissipation sheet at the second end part.
   (13)

The battery pack according to any one of (1) to (12), in which
the housing includes a protrusion at a position opposed to each of the first heat dissipation parts and the second heat dissipation parts,
each of the first heat dissipation parts and the second heat dissipation parts is in contact with corresponding one of the protrusions, and
all or a part of each of the third heat dissipation parts is not in contact with the housing.
   (14)

The battery pack according to any one of (1) to (13), further including
a battery holder that supports the batteries, in which
a thickness of a part, of the battery holder, that surrounds a peripheral surface of a first battery is larger than a thickness of a part, of the battery holder, that surrounds a peripheral surface of a second battery, where the first battery is one of the batteries that is surrounded by largest number of the batteries, and the second battery is one of the batteries that is surrounded by smallest number of the batteries.

In a battery pack according to an embodiment of the present disclosure, a plurality of energization tabs and a heat dissipation sheet may be provided between respective terminals of a plurality of batteries and a housing. This allows a part of heat generated by the batteries in the housing to propagate to the housing via the energization tabs and the heat dissipation sheet. A part of heat generated by one of the batteries, e.g., a first battery, propagates to another one of the batteries, e.g., a second battery, via the energization tab coupled to the first battery. Each of the energization tabs may have an internal resistance. Therefore, the energization tabs may also generate heat due to currents flowing through the energization tabs. A part of the heat generated by the energization tabs may propagate to the batteries coupled to the energization tabs. Accordingly, a heat generation distribution of the batteries may depend on a layout of the terminals and a layout of the energization tabs. According to an embodiment of the present disclosure, the heat dissipation sheet has a member pattern corresponding to the layout of the respective terminals of the batteries and the layout of the energization tabs. This helps to reduce unevenness of the heat generation distribution of the batteries by the heat dissipation sheet having the member pattern.

Note that when the heat dissipation sheet has a flat plate shape with no pattern, the heat generation distribution of the batteries is not so different from that in a battery pack with no heat dissipation sheet. Therefore, the heat dissipation sheet having the flat plate shape with no pattern has a smaller effect of reducing the unevenness of the heat generation distribution of the batteries. Accordingly, when the heat dissipation sheet having the member pattern is provided, the heat generation distribution of the batteries is more even, as compared with when no heat dissipation sheet is provided or when the heat dissipation sheet having the flat plate shape with no pattern is provided. It is thus possible to help to reduce a possibility of batteries varying in characteristic or lifetime.

Although the present disclosure has been described hereinabove in terms of the example embodiment and modification examples, the present disclosure is not limited thereto. It should be appreciated that variations may be made in the described example embodiment and modification examples by those skilled in the art without departing from the scope of the present disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a”, “an”, and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. do not denote any order or importance, but rather the terms first, second, etc. are used to distinguish one element from another.

The terms “substantially”, “approximately”, “about”, and their variants having the similar meaning thereto are defined as being largely but not necessarily wholly what is specified as understood by one of ordinary skill in the art.

The terms “disposed on”, “provided on”, “formed on”, and their variants having the similar meaning thereto as used herein refer to elements disposed directly in contact with each other or indirectly by having intervening structures therebetween.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery pack comprising:
a plurality of batteries each including a terminal;
a plurality of energization tabs coupled to the respective terminals of the batteries;
a heat dissipation sheet in contact with the energization tabs; and
a housing that houses the batteries, the energization tabs, and the heat dissipation sheet and is in contact with the heat dissipation sheet, wherein
the heat dissipation sheet has a member pattern corresponding to a layout of the respective terminals of the batteries and a layout of the energization tabs.

2. The battery pack according to claim 1, wherein
the heat dissipation sheet includes
a plurality of first heat dissipation parts each disposed at a position opposed to corresponding one of the terminals,
a plurality of second heat dissipation parts each disposed at a position opposed to a part, of corresponding one of the energization tabs, that is not opposed to any of the terminals, and
a plurality of third heat dissipation parts each disposed at a position not opposed to any of the terminals and the energization tabs, and
the first heat dissipation parts, the second heat dissipation parts, and the third heat dissipation parts form the member pattern.

3. The battery pack according to claim 2, wherein each of the energization tabs is configured to allow a temperature of each of the batteries at a time of energization to be higher than a temperature of each of the energization tabs at the time of the energization.

4. The battery pack according to claim 2, wherein each of the energization tabs includes Cu.

5. The battery pack according to claim 3, wherein a width of a part having a smallest width in each of the second heat dissipation parts is smaller than a width of a part having a smallest width in each of the third heat dissipation parts.

6. The battery pack according to claim 2, wherein each of the energization tabs is configured to allow a temperature of each of the batteries at a time of energization to be lower than a temperature of each of the energization tabs at the time of the energization.

7. The battery pack according to claim 2, wherein each of the energization tabs includes Al or Ni.

8. The battery pack according to claim 6, wherein a width of a part having a smallest width in each of the second heat dissipation parts is larger than a width of a part having a smallest width in each of the third heat dissipation parts.

9. The battery pack according to claim 2, wherein a thickness of a part having a smallest thickness in each of the third heat dissipation parts is smaller than a thickness of a part having a smallest thickness in each of the first heat dissipation parts and the second heat dissipation parts.

10. The battery pack according to claim 9, wherein
each of the first heat dissipation parts and the second heat dissipation parts is in contact with the housing, and
at least the part having the smallest thickness in each of the third heat dissipation parts is not in contact with the housing.

11. The battery pack according to claim 2, wherein an area of the first heat dissipation part opposed to the terminal of a first battery is larger than an area of the first heat dissipation part opposed to the terminal of a second battery, where the first battery is one of the batteries that is disposed in middle, and the second battery is one of the batteries that is disposed at a corner.

12. The battery pack according to claim 11, wherein
the heat dissipation sheet includes a first end part and a second end part,
each of the first end part and the second end part includes one or more of the first heat dissipation parts, one or more of the second heat dissipation parts, and one or more of the third heat dissipation parts,
each of the one or more second heat dissipation parts at the first end part is longer than each of the one or more second heat dissipation parts at the second end part, and
an area of the heat dissipation sheet at the first end part is larger than an area of the heat dissipation sheet at the second end part.

13. The battery pack according to claim 1, wherein
the housing includes a protrusion at a position opposed to each of the first heat dissipation parts and the second heat dissipation parts,
each of the first heat dissipation parts and the second heat dissipation parts is in contact with corresponding one of the protrusions, and
all or a part of each of the third heat dissipation parts is not in contact with the housing

14. The battery pack according to claim 1, further comprising
a battery holder that supports the batteries, wherein
a thickness of a part, of the battery holder, that surrounds a peripheral surface of a first battery is larger than a thickness of a part, of the battery holder, that surrounds a peripheral surface of a second battery, where the first battery is one of the batteries that is surrounded by largest number of the batteries, and the second battery is one of the batteries that is surrounded by smallest number of the batteries.
